(19) United States
(12) Patent Application Publication
(10) Pub. No.: US 2023/0020570 A1
(43) Pub. Date: Jan. 19, 2023

(54) SEMICONDUCTOR INTEGRATED CIRCUIT, SEMICONDUCTOR DEVICE, AND TEMPERATURE CHARACTERISTIC ADJUSTMENT METHOD

(71) Applicant: LAPIS Technology Co., Ltd., Yokohama (JP)

(72) Inventor: Takayoshi FUJINO, Yokohama (JP)

(73) Assignee: LAPIS Technology Co., Ltd., Yokohama (JP)

(21) Appl. No.: 17/865,552

(22) Filed: Jul. 15, 2022

(30) Foreign Application Priority Data
Jul. 19, 2021 (JP) 2021-118629

(51) Int. Cl. G05F 1/573; G05F 3/26

(52) U.S. Cl. CPC G05F 1/573; G05F 3/262

(57) ABSTRACT

An operational amplifier operates upon receiving supply of a first voltage and outputs a control voltage on the basis of a reference voltage. A first output transistor has a first electrode connected to a first voltage line that is a supply line for the first voltage; the first output transistor transmits a first current on the basis of the control voltage. An overcurrent protection circuit is connected to the operational amplifier, and includes a resistance unit for adjustment of a temperature coefficient.

### CROSS REFERENCE TO RELATED APPLICATION

This application is based upon and claims the benefit of priority of the prior Japanese Patent Application No. 2021-118629, filed on Jul. 19, 2021, the entire contents of which are incorporated herein by reference.

### TECHNICAL FIELD

The present invention relates to a semiconductor integrated circuit and a semiconductor device, and in particular, relates to a temperature characteristic adjustment method for a semiconductor integrated circuit having an overcurrent protection circuit and a semiconductor device having an overcurrent protection circuit.

### BACKGROUND ART

A linear regulator circuit is provided with an overcurrent protection circuit for protecting a circuit connected to the linear regulator circuit from an overcurrent (see, e.g., Japanese Patent Application Laid-Open Publication No. 2012-160083). The overcurrent protection circuit is constituted of a P-channel MOS transistor for copying a current flowing in an output transistor, a first transistor pair constituted of N-channel MOS transistors, and a second transistor pair constituted of P-channel MOS transistors for adjusting the threshold current for overcurrent protection and feeding back the threshold current to the gate of the output transistor, for example.

### SUMMARY OF THE INVENTION

It is common practice to provide a bipolar transistor as a second output transistor, in addition to a first output transistor that receives output from an operational amplifier directly at the gate, outside of a chip that constitutes a linear regulator circuit in order to increase the output current of the linear regulator circuit. The second output transistor outputs an output current according to the current outputted from the first output transistor.

It is preferable that the threshold current for overcurrent protection not change according to the ambient temperature. The current amplification factor of the second output transistor provided outside of the chip has positive temperature characteristics in which the value thereof increases as the temperature increases. Thus, where the output current that is outputted from the second output transistor is constant, the current outputted from the first output transistor has negative temperature characteristics in which the value thereof decreases as the temperature increases. The current flowing through a P-channel MOS transistor of the overcurrent protection circuit that copies the current of the first output transistor also takes on negative temperature characteristics. Thus, the current flowing through the P-channel MOS transistor of the overcurrent protection circuit changes according to the temperature, resulting in the threshold current for overcurrent protection, which is the upper limit value for the output current, also changing according to the temperature. Thus, the problem to be addressed has been the need to perform adjustment of temperature characteristics such that the threshold current for overcurrent protection does not change according to the temperature.

The present invention takes into consideration the above problem, and an object thereof is to provide a semiconductor integrated circuit and a semiconductor device by which it is possible to adjust temperature characteristics.

A semiconductor integrated circuit according to the present invention includes: an operational amplifier that is configured to operate upon receiving supply of a first voltage and output a control voltage on the basis of a reference voltage; a first output transistor having a first electrode connected to a first voltage line that is a supply line for the first voltage, the first output transistor being configured to transmit a first current on the basis of the control voltage; and an overcurrent protection circuit that is connected to the operational amplifier, and that includes a resistance unit for adjustment of a temperature coefficient.

According to the semiconductor integrated circuit and the semiconductor device of the present invention, it is possible to protect against overcurrent and to adjust the temperature characteristics.

### BRIEF DESCRIPTION OF THE DRAWINGS

FIG. 1 is a circuit diagram showing a configuration of a semiconductor device according to Embodiment 1 of the present invention.

FIG. 2 is a temperature characteristic diagram showing an example of temperature characteristics of currents when changing the resistance of a resistor in the semiconductor device of Embodiment 1.

FIG. 3 is a circuit diagram showing a configuration of a semiconductor device according to Embodiment 2 of the present invention.

FIG. 4 is a temperature characteristic diagram showing an example of temperature characteristics of currents when changing the resistance of a resistor in the semiconductor device of Embodiment 2.

FIG. 5 is a circuit diagram showing a configuration of a semiconductor device according to Embodiment 3 of the present invention.

FIG. 6 is a circuit diagram showing a configuration of an operational amplifier in a semiconductor device according to Embodiment 3.

### DETAILED DESCRIPTION OF EMBODIMENTS

Suitable embodiments of the present invention will be explained below in detail. In the description of embodiments and the affixed drawings below, parts that are substantially the same or equivalent to each other are assigned the same reference characters.

### Embodiment 1

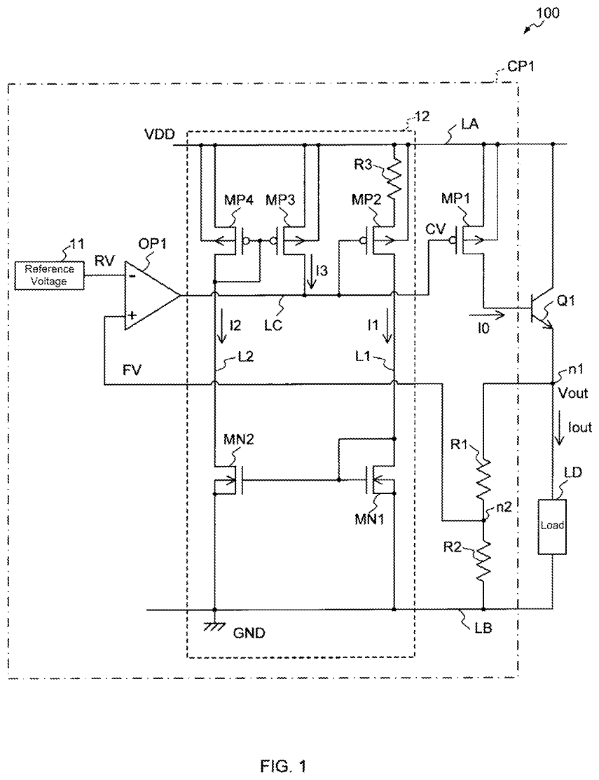

FIG. 1 is a circuit diagram showing a configuration of a semiconductor device 100 according to Embodiment 1 of the present invention. The semiconductor device 100 is constituted of a reference voltage generation unit 11, an operational amplifier OP1, a first output transistor MP1, a second output transistor Q1, resistors R1 and R2, and an overcurrent protection circuit 12. The reference voltage generation unit 11, the operational amplifier OP1, the first output transistor MP1, the second output transistor Q1, and the resistors R1 and R2 constitute a regulator circuit. A load LD is connected to the outside of the semiconductor device 100 and an output current lout of the semiconductor device 100 is supplied via a node n1 to the load LD. The load LD may alternatively be provided inside the semiconductor device 100.

The reference voltage generation unit 11, the operational amplifier OP1, the first output transistor MP1, the resistors R1 and R2, and the overcurrent protection circuit 12 are formed in a semiconductor integrated circuit CP1 on the same chip. Meanwhile, the second output transistor Q1 is provided outside of the semiconductor integrated circuit CP1 and is connected to the first output transistor MP1 and the resistor R1 in the semiconductor integrated circuit CP1.

The reference voltage generation unit 11 is a reference voltage source that is configured to generate the reference voltage of the semiconductor device 100. The reference voltage generation unit 11 generates a reference voltage RV and supplies the same to the inversion input terminal of the operational amplifier OP1.

The operational amplifier OP1 has an inversion input terminal, a non-inversion input terminal, and an output terminal, and is configured to output from the output terminal a voltage based on the voltage difference between the input voltage of the inversion input terminal and the input voltage of the non-inversion input terminal. In the present embodiment, the inversion input terminal of the operational amplifier OP1 has inputted thereto the reference voltage RV generated by the reference voltage generation unit 11. The non-inversion input terminal of the operational amplifier OP1 has inputted thereto a feedback voltage FV generated by the resistors R1 and R2. The operational amplifier OP1 operates by receiving a power source voltage VDD, and outputs a control voltage CV based on the voltage difference between the reference voltage RV and the feedback voltage FV to a control voltage line LC.

The first output transistor MP1 has a control electrode and two other electrodes. The first output transistor MP1 is constituted of a P-channel MOSFET of a first conductivity type, for example. Here, the control electrode is the gate and the two other electrodes are the source and drain; in the description below, the control electrode is assumed to be a gate and the other electrodes are assumed to be the source or drain. The first output transistor MP1 is configured to receive the control voltage CV outputted from the operational amplifier OP1 and transmit a current I0. The source and back gate of the first output transistor MP1 are connected to a supply line LA for the power source voltage VDD, which is a first voltage. The gate of the first output transistor MP1 is connected to the control voltage line LC. The first output transistor MP1 transmits from the drain a current I0 based on the control voltage CV applied to the gate.

The transistor Q1 is a second output transistor that is provided outside of the semiconductor integrated circuit CP1 and is configured to transmit an output current otuput on the basis of the current I0 outputted from the first output transistor MP1. The transistor Q1 has three electrodes. The transistor Q1 is constituted of an NPN bipolar transistor, for example. Here, the three electrodes are the base, the collector, and the emitter; in the description below, each electrode is assumed to be a base, a collector, or an emitter. The collector of the transistor Q1 is connected to the supply line LA for the power source voltage VDD. The base of the transistor Q1 is connected to the drain of the first output transistor MP1. The emitter of the transistor Q1 is connected to the node n1, which is the output node for the output voltage Vout. The output current Iout having a value based on the value of the current I0 is transmitted from the emitter of the transistor Q1.

The resistors R1 and R2 are resistance elements constituting a feedback voltage generation unit that generates the feedback voltage FV. The first end of the resistor R1 is connected to the node n1. The second end of the resistor R1 is connected to the node n2. The first end of the resistor R2 is connected to the node n2. The second end the resistor R2 is connected to a supply line LB for a ground potential GND, which is a second voltage. The resistors R1 and R2 are configured to cause the output voltage Vout that is the voltage of the node n1 to be separated from the ground voltage GND, and outputted from the node n2 as the feedback voltage FV. The feedback voltage FV is supplied to the non-inversion input terminal of the operational amplifier OP1.

The overcurrent protection circuit 12 is connected to the supply line LA for the power source voltage VDD and the supply line LB for the ground voltage GND and is configured to limit the value of the current I0 outputted from the first output transistor MP1 to less than or equal to a prescribed current value, thereby preventing an overcurrent from flowing into the load LD. The overcurrent protection circuit 12 of the present embodiment is constituted of transistors MP2, MP3, MP4, MN1, and MN2 and a resistor R3.

The transistor MP2 constitutes a current mirror together with the first output transistor MP1, and is a current transmission transistor that transmits a current that is a copy of the current I0, which is the output current of the first output transistor MP1, or in other words, a current I1 having a value based on the value of the current I0. In the present embodiment, the transistor MP2 has the same size as the first output transistor MP1, and transmits the current I1 having the same value as the current I0 when the resistance of the resistor R3 is 0.

The transistor MP2 has a control electrode and two other electrodes. The transistor MP2 is a P-channel MOSFET, for example. Here, the control electrode is the gate and the two other electrodes are the source and drain; in the description below, the control electrode is assumed to be a gate and the other electrodes are assumed to be the source or drain. The gate of the transistor MP2 is connected to the control voltage line LC, which is the supply line for the control voltage CV. The back gate of the transistor MP2 is connected to the supply line LA for the power source voltage VDD. The drain of the transistor MP2 is connected to a line L1. According to this configuration, the current I1 is transmitted from the drain of the transistor MP2 to the line L1.

The transistors MN1 and MN2 are a first transistor pair constituting a current minor. The transistors MN1 and MN2 are each an N-channel MOSFET, for example. In the present embodiment, the transistors MN1 and MN2 have the same size.

The transistor MN1 has a control electrode and two other electrodes. If the transistor MN1 is an N-channel MOSFET, then the control electrode is a gate and the two other electrodes are a source and drain. In the description below, the control electrode is assumed to be a gate and the other electrodes are assumed to be the source or drain. The source and back gate of the transistor MN1 are connected to the supply line LB for the ground voltage GND. The gate and the drain of the transistor MN1 are connected to each other and connected to the drain of the transistor MP2 via the line L1.

The transistor MN2 has a control electrode and two other electrodes. If the transistor MN2 is an N-channel MOSFET, then the control electrode is a gate and the two other electrodes are a source and drain. In the description below, the control electrode is assumed to be a gate and the other electrodes are assumed to be the source or drain. The source and back gate of the transistor MN2 are connected to the supply line LB for the ground voltage GND. The drain of the transistor MN2 is connected to a line L2. The gate of the transistor MN2 is connected to the gate and drain of the transistor MN1.

As a result of the current minor constituted of the transistors MN1 and MN2, a current resulting from copying the current I1 of the line L1, or in other words, a current 12 having a value based on the value of the current I1 is transmitted to the line L2. In the present embodiment, the transistors MN1 and MN2 are the same size, and thus, the current 12 having the same value as the current I1 is transmitted to the line L2.

The transistors MP3 and MP4 are a second transistor pair constituting a current mirror. The transistors MP3 and MP4 are each a P-channel MOSFET, for example. In the present embodiment, the transistors MP3 and MP4 have the same size.

The transistor MP3 has a control electrode and two other electrodes. If the transistor MP3 is a P-channel MOSFET, then the control electrode is a gate and the pair of electrodes are a source and drain. In the description below, the control electrode is assumed to be a gate and the other electrodes are assumed to be the source or drain. The source and the back gate of the transistor MP3 are connected to the supply line LA for the power source voltage VDD. The drain of the transistor MP3 is connected to the control voltage line LC, which is the supply line for the control voltage CV. The gate of the transistor MP3 is connected to the line L2.

The transistor MP4 has a control electrode and a pair of electrodes. If the transistor MP4 is a P-channel MOSFET, then the control electrode is a gate and the pair of electrodes are a source and drain. In the description below, the control electrode is assumed to be a gate and the other electrodes are assumed to be the source or drain. The source and the back gate of the transistor MP4 are connected to the supply line LA for the power source voltage VDD. The gate and the drain of the transistor MP4 are connected to the gate of the transistor MP3 and connected to the line L2.

As a result of the current minor constituted of the transistors MP3 and MP4, a current resulting from copying the current 12 of the line L2, or in other words, a current 13 having a value based on the value of the current 12 is transmitted by the transistor MP3. In the present embodiment, the transistors MP3 and MP4 are the same size, and thus, the current 13 having the same value as the current 12 is transmitted.

The current 12 generated by the transistors MN1 and MN2 copying the current I1 is transmitted, and the current 13 generated by the transistors MP3 and MP4 copying the current 12 is transmitted, resulting in the voltage of the control line LC being raised towards the power source voltage VDD according to the value of the current 13. As a result, the control voltage CV is adjusted by the transistors MN1 and MN2 and the transistors MP3 and MP4, and the value of the current I0 outputted from the first output transistor is adjusted. That is, the threshold current for overcurrent protection is adjusted. The threshold current for overcurrent protection refers to the upper limit value of the output current Iout. By setting the threshold current according to the condition of the load LD, it is possible to prevent an overcurrent flowing to the load LD.

The resistor R3 has a first end connected to a supply line LA for the power source voltage VDD and a second end connected to the source of the transistor MP2. The resistor R3 has negative temperature characteristics, and is a temperature coefficient adjustment resistance element for adjusting the temperature coefficient of the current I1 flowing in the line L1. Here, the temperature characteristics refer to the change in characteristics resulting from a temperature change, and the temperature coefficient refers to the degree of change, or in other words, the slope with respect to the temperature change. That is, negative temperature characteristics refer to a case in which the value thereof decreases as the temperature increases. The resistor R3 is an example of a resistance unit. In the present embodiment, by changing the resistance of the resistor R3, it is possible to adjust the temperature coefficient of the current IL Adjustment of the temperature coefficient will be described later.

The resistor R3 is also a current restriction resistance element provided in order to adjust the threshold current for overcurrent protection. In the present embodiment, by changing the resistance of the resistor R3, it is possible to adjust the value of the current I1, and thereby to adjust the control voltage CV. Thus, by changing the resistance of the resistor R3, it is possible to adjust the threshold current for overcurrent protection.

First, the operation of the overcurrent protection circuit 12 in the semiconductor device 100 of the present embodiment shown in FIG. 1 will be described. The first output transistor MP1 transmits the current I0 upon receiving application thereto of the control voltage CV, and as a result of the transistor MP2, the current IL which is a copy of the current I0, is transmitted to the line L1. Then, the current 12 generated by the transistors MN1 and MN2 copying the current I1 in the line L1 is transmitted to the line L2, and the current 13 generated by the transistors MP3 and MP4 copying the current 12 in the line L2 is transmitted by the transistor MP3. As a result of the voltage of the control line LC being raised towards the power source voltage VDD according to the value of the current 13, the value of the current I0 of the first output transistor is limited, resulting in the value of the output current Iout also being limited. As a result, an overcurrent is prevented from flowing to the load LD.

Next, adjustment of the temperature coefficient will be described. First, in the semiconductor device 100 of the present embodiment shown in FIG. 1, a current amplification factor hfe of the transistor Q1, which is the second output transistor provided outside of the semiconductor integrated circuit CP1, has positive temperature characteristics. Thus, where the output current Iout that is outputted from the second output transistor Q1 is constant, the current I0 outputted from the first output transistor MP1 has negative temperature characteristics. Furthermore, the current I1 flowing from the drain of the transistor MP2 is a copy of the current I0 outputted from the first output transistor MP1, and thus, the current I1 also has negative temperature characteristics.

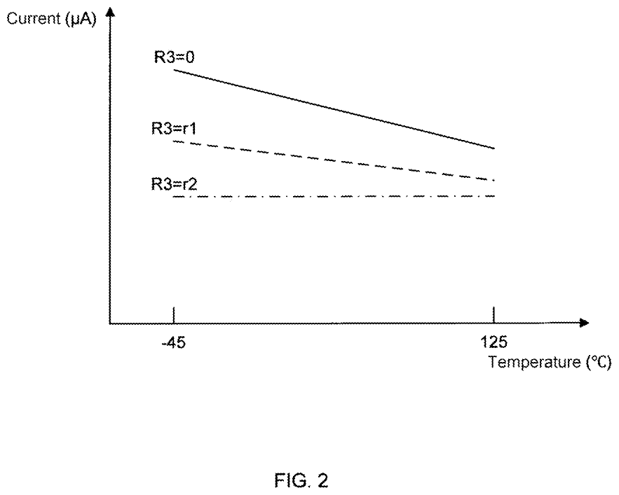

FIG. 2 is a temperature characteristic diagram showing an example of temperature characteristics of the current I1 flowing to the drain of the transistor MP2 when the resistance of the resistor R3 is changed. In FIG. 2, a case in which the resistance of the resistor R3 is 0 is indicated with a solid line, a case in which the resistance of the resistor R3 is r1 is indicated with a dashed line, and a case in which the resistance of the resistor R3 is r2 is indicated with a dashed-dotted line, for example. Here, the resistance has a relationship of 0<r1<r2.

FIG. 2 shows the temperature coefficient of the current I1 where the resistance of the resistor R3 is changed between 0, r1, and r2. As described above, the temperature coefficient of the current I1 indicates the degree of change, or in other words, the slope of the value of the current I1 in relation to a temperature change. In comparing the temperature coefficients of the current I1 at the respective resistances, the temperature coefficient is greater when the resistance of the resistor R3 is r1 as compared to when the resistance is 0. Furthermore, the temperature coefficient is greater when the resistance of the resistor R3 is r2 as compared to when the resistance is r1. The temperature characteristics are a change in characteristics resulting from temperature change and it is preferable that the temperature characteristics be as small as possible; thus, it is preferable that the resistance of the resistor R3 take on a value by which the absolute value of the temperature coefficient of the current I1 is reduced. Thus, if the temperature characteristics of the current I1 are the temperature characteristics shown in FIG. 2, for example, then it is preferable that r2, which is the greatest resistance, be selected as the resistance of the resistor R3 such that the absolute value of the temperature coefficient of the current I1 is reduced.

Thus, by increasing the resistance of the resistor R3, it is possible to adjust the temperature coefficient of the current I1 towards the positive temperature characteristic side. The positive temperature characteristic side includes not only a case in which the temperature characteristics of the current I1 change to positive temperature characteristics, but also the case such as that shown in FIG. 2 in which the temperature coefficient of the current I1 increases and the temperature coefficient approaches positive temperature characteristics. The resistance of the resistor R3 is adjusted during manufacturing of the semiconductor device 100, for example.

As described above, the semiconductor device 100 of the present embodiment has a resistor R3 that is a temperature characteristic adjustment resistor. The current IL which is the output current of the transistor MP2, has a negative temperature coefficient, but by adjusting the resistance of the resistor R3, it is possible to adjust the temperature coefficient of the current I1, which is the output current of the transistor MP2, towards the positive temperature characteristic side.

Thus, according to the semiconductor integrated circuit CP1 and the semiconductor device 100 of the present embodiment, it is possible to protect against overcurrent using the overcurrent protection circuit and to adjust the temperature characteristics.

### Embodiment 2

Next, Embodiment 2 of the present invention will be explained. A semiconductor device according to Embodiment 2 has a configuration in which a resistor R4 is added to Embodiment 1, and differs from the semiconductor device of Embodiment 1 in terms of the configuration of the overcurrent protection circuit.

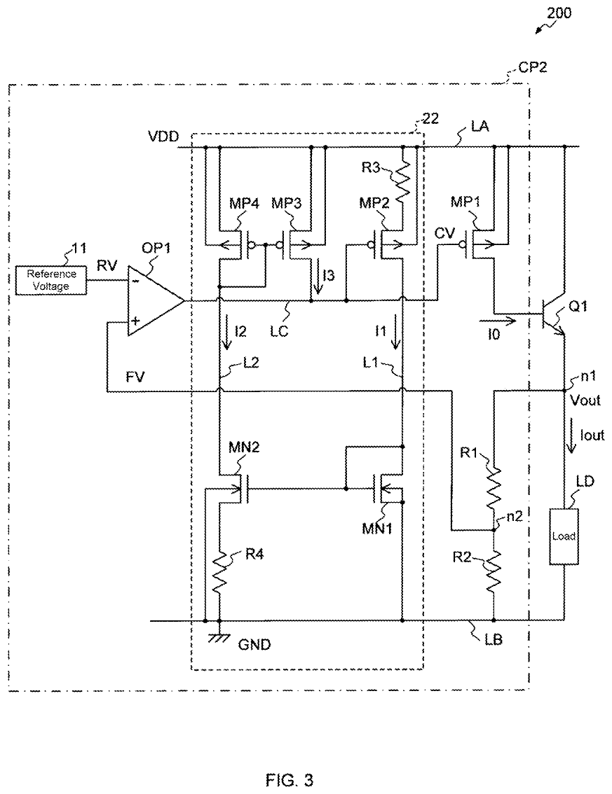

FIG. 3 is a circuit diagram showing a configuration of a semiconductor device 200 according to the present embodiment. In FIG. 3, portions in the drawings that are the same or similar to those of FIG. 1 are assigned the same reference characters. The semiconductor device 200 is constituted of a reference voltage generation unit 11, an operational amplifier OP1, a first output transistor MP1, a second output transistor Q1, resistors R1 and R2, and an overcurrent protection circuit 22. The reference voltage generation unit 11, the operational amplifier OP1, the first output transistor MP1, the second output transistor Q1, and the resistors R1 and R2 constitute a regulator circuit. A load LD is connected to the outside of the semiconductor device 200 and an output current Iout of the semiconductor device 200 is supplied via a node n1 to the load LD. The load LD may alternatively be provided inside the semiconductor device 200.

The reference voltage generation unit 11, the operational amplifier OP1, the first output transistor MP1, the resistors R1 and R2, and the overcurrent protection circuit 22 are formed in a semiconductor integrated circuit CP2 on the same chip. Meanwhile, the second output transistor Q1 is provided outside of the semiconductor integrated circuit CP2 and is connected to the first output transistor MP1 and the resistor R1 in the semiconductor integrated circuit CP2.

The overcurrent protection circuit 22 is constituted of transistors MP2, MP3, MP4, MN1, and MN2 and resistors R3 and R4.

The resistor R4 has a first end connected to a supply line LB for a ground voltage GND and a second end connected to the source of the transistor MN2. The resistor R4 has negative temperature characteristics, and is a temperature coefficient adjustment resistance element for adjusting the temperature coefficient of the current 12 flowing in the line L2. The resistor R4 is an example of a resistance unit. In the present embodiment, by changing the resistance of the resistor R4, it is possible to adjust the temperature coefficient of the current 12. Adjustment of the temperature coefficient will be described later.

The resistor R4 is also a current restriction resistance element provided in order to adjust the threshold current for the overcurrent protection circuit 12. In the present embodiment, by changing the resistance of the resistor R4, it is possible to adjust the value of the current 12, and thereby to adjust the control voltage CV. Thus, by changing the resistance of the resistor R4, it is possible to adjust the threshold current for overcurrent protection.

Next, adjustment of the temperature coefficient using the resistor R4 will be described. First, in the semiconductor device 200 of the present embodiment shown in FIG. 3, the current 12 that flows to the drain of the transistor MN2 is a copy of the current I1 flowing to the drain of the transistor MP2, and thus, like the current IL the current 12 also has negative temperature characteristics.

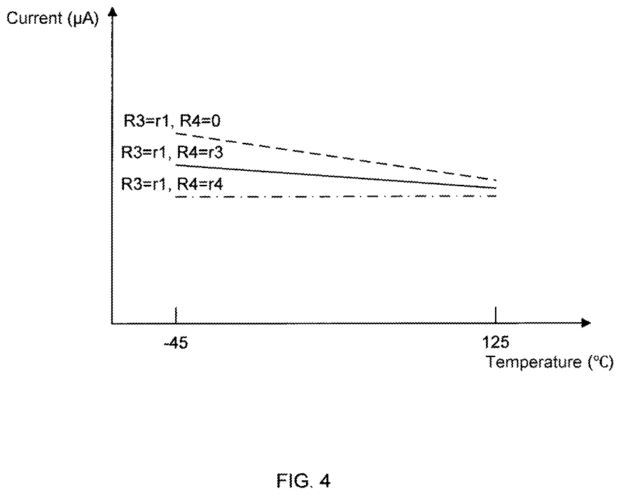

FIG. 4 is a temperature characteristic diagram showing an example of temperature characteristics of the current 12 flowing to the drain of the transistor MN2 when the resistance of the resistor R4 is changed. In FIG. 4, a case in which the resistance of the resistor R3 is r1 and the resistance of the resistor R4 is r3 is indicated with a solid line, a case in which the resistance of the resistor R3 is r1 and the resistance of the resistor R4 is 0 is indicated with a dashed line, and a case in which the resistance of the resistor R3 is r1 and the resistance of the resistor R4 is r4 is indicated with a dashed-dotted line. Here, the resistance has a relationship of 0<r3<r4.

FIG. 4 shows the temperature coefficient of the current 12 where the resistance of the resistor R3 is constant and the resistance of the resistor R4 is changed between 0, r3, and r4. As described above, the temperature coefficient of the current 12 indicates the degree of change, or in other words, the slope of the value of the current 12 in relation to a temperature change. In comparing the temperature coefficients of the current 12 at the respective resistances, the temperature coefficient is greater when the resistance of the resistor R4 is r3 as compared to when the resistance of the resistor R4 is 0. Furthermore, the temperature coefficient is greater when the resistance of the resistor R4 is r4 as compared to when the resistance of the resistor R4 is r3. The temperature characteristics are a change in characteristics resulting from temperature change and it is preferable that the temperature characteristics be as small as possible; thus, it is preferable that the resistance of the resistor R4 take on a value by which the absolute value of the temperature coefficient is reduced. Thus, if the temperature characteristics of the current 12 are the temperature characteristics shown in FIG. 4, for example, then it is preferable that r4, which is the greatest resistance, be selected as the resistance of the resistor R4 such that the absolute value of the temperature coefficient of the current I1 is reduced.

Thus, by increasing the resistance of the resistor R4, it is possible to adjust the temperature coefficient of the current 12 towards the positive temperature characteristic side. The positive temperature characteristic side includes not only a case in which the temperature characteristics of the current 12 change to positive temperature characteristics, but also the case such as that shown in FIG. 4 in which the temperature coefficient of the current 12 increases and the temperature coefficient approaches positive temperature characteristics. The resistance of the resistor R4 is adjusted during manufacturing of the semiconductor device 200, for example.

Similar to the semiconductor device 100 of Embodiment 1, in the semiconductor device 200, by adjusting the resistance of the resistor R3, it is possible to adjust the temperature coefficient of the current I1, which flows in the transistor MP2, towards the positive temperature characteristic side. In other words, according to the semiconductor device 200 of the present embodiment, by performing two-stage adjustment involving adjustment using the resistor R3 and adjustment using the resistor R4, it is possible to adjust the temperature coefficients of the current I1 flowing in the transistor MP2 and the current 12 flowing through the transistor MN2 towards the positive temperature characteristic side.

Also, a threshold voltage V_{thMP2} of the transistor MP2 for when the resistor R3 is provided is represented by the following formula 1.

V_{thMP2}=Vₜₕ₀ +γ(\sqrt{|2φ+l₁R₃ |}−\sqrt{2φ_{F}}) Formula 1

Vₜₕ₀ represents the threshold voltage of the transistor where the substrate potential is 0V, and (φF represents the potential difference between the Fermi level of an impurity semiconductor and the intrinsic Fermi level.

If, for example, only the resistor R3 were provided as the temperature coefficient adjustment resistor and an adjustment were to be performed by changing only the resistance of the resistor R3, then if the temperature coefficient of the current amplification factor hfe of the transistor Q1 were large, then the resistance of the resistor R3 would also need to be large. As a result, in formula 1, the threshold voltage V_{thMP2} of the transistor MP2 increases as the resistance of the resistor R3 increases. In particular, if the threshold voltage Vₜₕ₀, which is the threshold voltage of the transistor when the substrate potential is 0V, is small, then the threshold voltage V_{thMP2} of the transistor MP2 is susceptible to effects from the resistance of the resistor R3, and there is a possibility of increased offset from the threshold voltage Vₜₕ₀ of the first output transistor MP1. If the offset in threshold voltage is increased in this manner, then the error in copying the current also increases. As a result, variations in manufacturing would result in variations in the error in copying the current, which has made it difficult to adjust the threshold current for overcurrent protection.

However, according to the semiconductor device 200 of the present embodiment, by performing adjustment of the temperature coefficient of the current flowing through the overcurrent protection circuit in two stages, it is possible to adjust the temperature coefficient without an increase in resistance in the resistors R3 and R4, and thus, it is possible for the threshold voltage of the transistors MP2 and MN2, which are transistors for copying the current, to be brought closer to the threshold voltage of the first output transistor MP1, the current of which is copied. As a result, it would be easy to adjust the threshold current for overcurrent protection, even given variations in manufacturing.

In the present embodiment, a case was described in which the resistors R3 and R4 were provided as resistance units of the overcurrent protection circuit 22, but the configuration is not limited thereto. For example, a resistor R5 connected between the supply line LA for the power source voltage VDD and the source of the transistor MP3 may be additionally provided as a new resistor (not shown), with adjustment of the temperature coefficient of the current flowing through the overcurrent protection circuit being conducted in three stages. By adjusting the temperature coefficient of the current flowing through the overcurrent protection circuit in three stages, it is possible to adjust the temperature coefficient such that the resistance is even less susceptible to increasing, and it would be easy to adjust the threshold current for overcurrent protection.

### Embodiment 3

Next, Embodiment 3 of the present invention will be explained. A semiconductor device circuit according to Embodiment 3 differs from the semiconductor devices of Embodiments 1 and 2 in terms of the configuration of the overcurrent protection circuit.

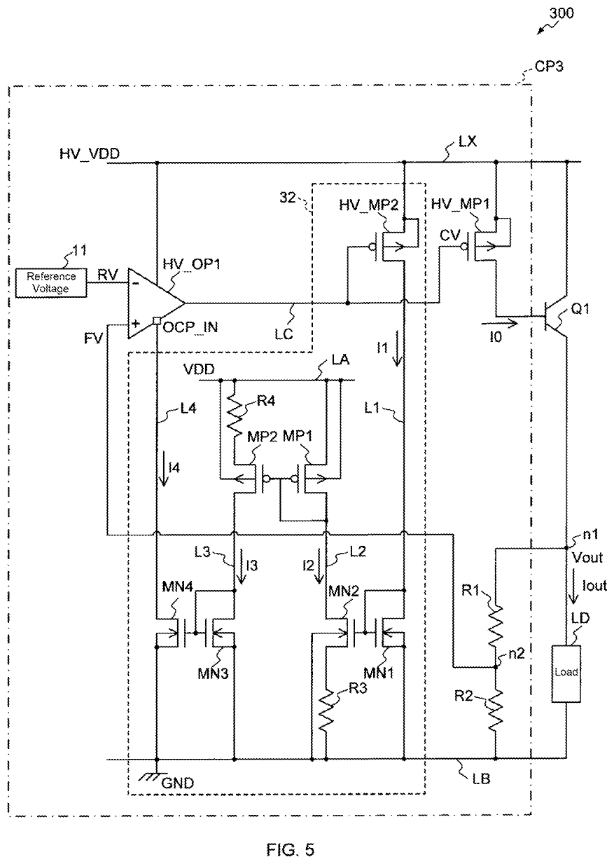

FIG. 5 is a circuit diagram showing a configuration of a semiconductor device 300 according to the present embodiment. The semiconductor device 300 operates on the basis of a high-power source voltage HV_VDD. In FIG. 5, portions in the drawings that are the same or similar to those of FIG. 1 are assigned the same reference characters. The semiconductor device 300 is constituted of a reference voltage generation unit 11, an operational amplifier HV_OP1, a first output transistor HV_MP1, a second output transistor Q1, resistors R1 and R2, and an overcurrent protection circuit 32. The reference voltage generation unit 11, the operational amplifier HV_OP1, the first output transistor HV_MP1, the second output transistor Q1, and the resistors R1 and R2 constitute a regulator circuit. A load LD is connected to the outside of the semiconductor device 300 and an output current Iout of the semiconductor device 300 is supplied via a node n1 to the load LD. The load LD may alternatively be provided inside the semiconductor device 300.

The reference voltage generation unit 11, the operational amplifier HV_OP1, the first output transistor HV_MP1, the resistors R1 and R2, and the overcurrent protection circuit 32 are formed in a semiconductor integrated circuit CP3 on the same chip. Meanwhile, the second output transistor Q1 is provided outside of the semiconductor integrated circuit CP3 and is connected to the first output transistor HV_MP1 and the resistor R1 provided in the semiconductor integrated circuit CP3.

The operational amplifier the HV_OP1 has a high withstand voltage and operates on the basis of the high-power source voltage HV_VDD. The operational amplifier HV_OP1 outputs, to a control voltage line LC, a control voltage CV based on the voltage difference between the reference voltage RV inputted to the inversion input terminal and the feedback voltage FV inputted to the non-inversion input terminal

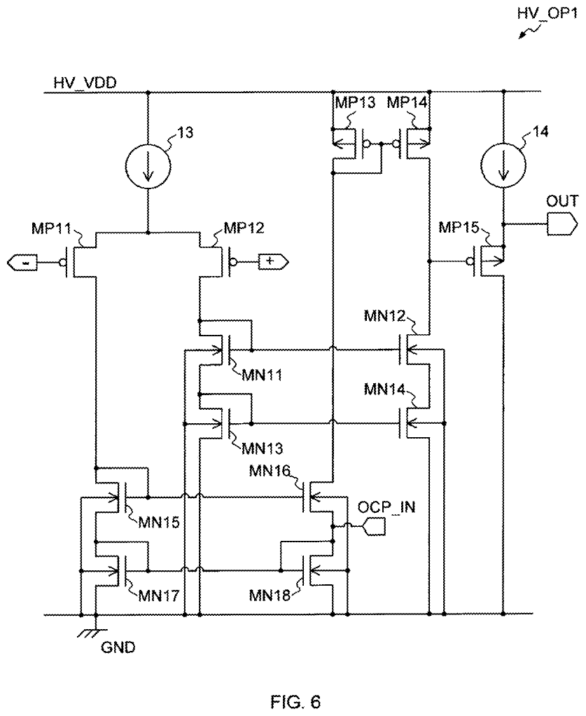

FIG. 6 is a circuit diagram showing the configuration of the operational amplifier HV_OP1. The operational amplifier HV_OP1 is constituted of fixed current sources 13 and 14, transistors MP11 and MP12 constituting an input differential pair, transistors MN11 and MN12 constituting a current mirror pair, transistors MN13 and MN14, transistors MN15 and MN16, transistors MN17 and MN18, transistors MP13 and MP14, and a transistor MP15 constituting an output stage. The transistors MP11 and MP12 constituting the input differential pair are respectively connected to the inversion input terminal and the non-inversion input terminal. An output terminal OUT is connected to the control voltage line LC.

The transistors MN11 to MN18 each have a control electrode and two other electrodes. The transistors MN11 to MN18 are N-channel MOSFETs, for example, and the control electrode is a gate and the two other electrodes are a source and drain. In the description below, the control electrode is assumed to be a gate and the other electrodes are assumed to be the source or drain. An overcurrent protection terminal OCP_IN is provided between the source of the transistor MN16 and the drain of the transistor MN18. According to this configuration, the voltage of the output terminal OUT of the operational amplifier HV_OP1 is limited by being brought down towards the ground voltage GND side by the current flowing through the operational amplifier HV_OP1.

With reference to FIG. 5, the first output transistor HV_MP1 is constituted of an N-channel MOSFET with a high withstand voltage compatible with the high-power source voltage HV_VDD, for example. The first output transistor HV_MP1 is a first output transistor that receives the control voltage CV outputted from the operational amplifier HV_OP1 and transmits a current I0. The first output transistor HV_MP1 has a control electrode and two other electrodes. If the first output transistor HV_MP1 is a P-channel MOSFET, then the control electrode is a gate and the two other electrodes are a source and drain. In the description below, the control electrode is assumed to be a gate and the other electrodes are assumed to be the source or drain. The source and back gate of the first output transistor HV_MP1 are connected to a supply line LX for the high-power source voltage HV_VDD, which is a first voltage. The gate of the first output transistor HV_MP1 is connected to the control voltage line LC. The first output transistor HV_MP1 transmits from the drain a current I0 based on the control voltage CV applied to the gate.

The transistor Q1 is a second output transistor that is provided outside of the semiconductor integrated circuit CP3 and transmits an output current Iout on the basis of the current I0 outputted from the first output transistor HV_MP1. The transistor Q1 has three electrodes. The transistor Q1 is constituted of an NPN bipolar transistor, for example. Here, the three electrodes are the collector, the base, and the emitter; in the description below, each electrode is assumed to be a collector, a base, or an emitter. The transistor Q1 has a collector that is connected to the supply line LX for the high-power source voltage HV_VDD and a base that is connected to the drain of the first output transistor HV_MP1. The output current Iout having a value based on the value of the current I0 is transmitted from the emitter of the transistor Q1.

The resistors R1 and R2 are resistance elements constituting a feedback voltage generation unit that generates the feedback voltage FV. The feedback voltage FV is supplied to the non-inversion input terminal of the operational amplifier HV_OP1.

The overcurrent protection circuit 32 is connected to the supply line LX for the high-power source voltage HV_VDD and the supply line LB for the ground voltage GND and limits the value of the current I0 outputted from the first output transistor HV_MP1 to less than or equal to a prescribed current value, thereby preventing an overcurrent from flowing into the load LD. The overcurrent protection circuit 32 is constituted of transistors HV_MP2, MP1, MP2, MN1, MN2, MN3, and MN4 and resistors R3 and R4.

The transistor HV_MP2 constitutes a current mirror together with the first output transistor HV_MP1, and is a current transmission transistor that transmits a current that is a copy of the current I0, which is the output current of the first output transistor HV_MP1, or in other words, a current I1 having a value based on the value of the current 10. The transistor HV_MP2 is constituted of a P-channel MOSFET with a high withstand voltage compatible with the high-power source voltage HV_VDD, for example. In the present embodiment, the transistor HV_MP2 has the same size as the first output transistor HV_MP1.

The transistor HV_MP2 has a control electrode and two other electrodes. If the transistor HV_MP2 is a P-channel MOSFET, then the control electrode is a gate and the two other electrodes are a source and drain. In the description below, the control electrode is assumed to be a gate and the other electrodes are assumed to be the source or drain. The gate of the transistor HV_MP2 is connected to the control voltage line LC, which is the supply line for the control voltage CV. The back gate of the transistor MP2 is connected to the supply line LX for the power source voltage HV_VDD. The drain of the transistor HV_MP2 is connected to a line L1. According to this configuration, the current I1 is transmitted from the drain of the transistor HV_MP2 to the line L1. The transistor HV_MP2 has the same size as the first output transistor HV_MP1, and thus, the current I1 has the same value as the current I0.

The transistors MN1 and MN2 are a first transistor pair constituting a current minor. The transistors MN1 and MN2 are constituted of N-channel MOSFETs with a low withstand voltage compatible with the low-power source voltage VDD, for example. In the present embodiment, the transistors MN1 and MN2 have the same size.

The transistor MN1 has a control electrode and two other electrodes. If the transistor MN1 is an N-channel MOSFET, then the control electrode is a gate and the two other electrodes are a source and drain. In the description below, the control electrode is assumed to be a gate and the other electrodes are assumed to be the source or drain. The source and back gate of the transistor MN1 are connected to the supply line LB for the ground voltage GND. The gate and the drain of the transistor MN1 are connected to each other and connected to the drain of the transistor HV_MP2 via the line L1.

The transistor MN2 has a control electrode and two other electrodes. If the transistor MN1 is an N-channel MOSFET, then the control electrode is a gate and the two other electrodes are a source and drain. In the description below, the control electrode is assumed to be a gate and the other electrodes are assumed to be the source or drain. The gate of the transistor MN2 is connected to the gate and drain of the transistor MN1. The drain of the transistor MN2 is connected to a line L2. The source and back gate of the transistor MN2 are connected to the supply line LB for the ground voltage GND via the resistor R3.

As a result of the current minor constituted of the transistors MN1 and MN2, a current resulting from copying the current I1 of the line L1, or in other words, a current 12 having a value based on the value of the current I1 is transmitted to the line L2. In the present embodiment, the transistors MN1 and MN2 have the same size, and thus, where the resistance of the resistor R3 is 0, the current 12 has the same value as the current IL

The transistors MP1 and MP2 are a second transistor pair constituting a current mirror. The transistors MP1 and MP2 are constituted of P-channel MOSFETs with a low withstand voltage compatible with the low-power source voltage VDD, for example. In the present embodiment, the transistors MP1 and MP2 have the same size.

The transistor MP1 has a control electrode and two other electrodes. If the transistor MP1 is a P-channel MOSFET, then the control electrode is a gate and the two other electrodes are a source and drain. In the description below, the control electrode is assumed to be a gate and the other electrodes are assumed to be the source or drain. The source and the back gate of the transistor MP1 are connected to the supply line LA for the power source voltage VDD. The gate and drain of the transistor MP1 are connected to the drain of the transistor MN2 via the line L2.

The transistor MP2 has a control electrode and two other electrodes. If the transistor MP2 is a P-channel MOSFET, then the control electrode is a gate and the two other electrodes are a source and drain. In the description below, the control electrode is assumed to be a gate and the other electrodes are assumed to be the source or drain. The gate of the transistor MP2 is connected to the gate and drain of the transistor MP1 and connected to the line L2. The drain of the transistor MP2 is connected to a line L3. The source and back gate of the transistor MP2 are connected to the supply line LA for the power source voltage VDD via the resistor R4.

As a result of the current minor constituted of the transistors MP1 and MP2, a current resulting from copying the current 12 of the line L2, or in other words, a current 13 having a value based on the value of the current 12 is transmitted to the line L3. In the present embodiment, the transistors MP1 and MP2 have the same size, and thus, where the resistance of the resistor R4 is 0, the current 13 has the same value as the current 12.

The transistors MN3 and MN4 are the third transistor pair constituting a current minor. The transistors MN3 and MN4 are constituted of N-channel MOSFETs with a low withstand voltage compatible with the low-power source voltage VDD, for example. In the present embodiment, the transistors MN3 and MN4 have the same size.

The transistor MN3 has a control electrode and two other electrodes. If the transistor MN3 is an N-channel MOSFET, then the control electrode is a gate and the two other electrodes are a source and drain. In the description below, the control electrode is assumed to be a gate and the other electrodes are assumed to be the source or drain. The source and back gate of the transistor MN3 are connected to the supply line LB for the ground voltage GND. The gate and the drain of the transistor MN3 are connected to each other and connected to the drain of the transistor MP2 via the line L3.

The transistor MN4 has a control electrode and two other electrodes. If the transistor MN4 is an N-channel MOSFET, then the control electrode is a gate and the two other electrodes are a source and drain. In the description below, the control electrode is assumed to be a gate and the other electrodes are assumed to be the source or drain. The gate of the transistor MN4 is connected to the gate and drain of the transistor MN3. The source and back gate of the transistor MN4 are connected to the supply line LB for the ground voltage GND. The drain of the transistor MN4 is connected to the overcurrent protection terminal OCP_IN of the operational amplifier HV_OP1 via a line L4.

As a result of the current minor constituted of the transistors MN3 and MN4, a current resulting from copying the current 13 of the line L3, or in other words, a current 14 having a value based on the value of the current 13 is transmitted to the line L4. In the present embodiment, the transistors MN3 and MN4 have the same size, and thus, the current 14 has the same value as the current 13.

The current 12 generated by the transistors MN1 and MN2 copying the current I1 is transmitted, the current 13 generated by the transistors MP1 and MP2 copying the current 12 is transmitted, and the current 14 generated by the transistors MN3 and MN4 copying the current 13 is transmitted, resulting in the voltage of the output terminal OUT of the operational amplifier HV_OP1 being lowered towards the ground voltage GND according to the value of the current 14. As a result, the control voltage CV is adjusted by the transistors MN1 and MN2, the transistors MP1 and MP2, and the transistors MN3 and MN4, and the value of the current I0 outputted from the first output transistor is adjusted. That is, the threshold current for overcurrent protection is adjusted.

The resistor R3 has a first end connected to a supply line LB for a ground voltage GND and a second end connected to the source of the transistor MN2. The resistor R3 has negative temperature characteristics, and is a temperature coefficient adjustment resistance element for adjusting the temperature coefficient of the current 12 flowing in the line L2. The resistor R3 is an example of a resistance unit. In the present embodiment, by changing the resistance of the resistor R3, it is possible to adjust the temperature coefficient of the current 12.

The resistor R4 has a first end connected to a supply line LA for the low-power source voltage VDD and a second end connected to the source of the transistor MP2. The resistor R4 has negative temperature characteristics, and is a temperature coefficient adjustment resistance element for adjusting the temperature coefficient of the current 13 flowing in the line L3. The resistor R4 is an example of a resistance unit. In the present embodiment, by changing the resistance of the resistor R4, it is possible to adjust the temperature coefficient of the current 13.

The resistors R3 and R4 are also current restriction resistance elements provided in order to adjust the threshold current for overcurrent protection. In the present embodiment, by changing the resistance of the resistors R3 and R4, it is possible to adjust the value of the currents 12 and 13, and thereby to adjust the control voltage CV. Thus, by changing the resistance of the resistors R3 and R4, it is possible to adjust the threshold current for overcurrent protection.

Next, adjustment of the temperature coefficient will be described. First, in the semiconductor device 300 of the present embodiment shown in FIG. 5, a current amplification factor hfe of the transistor Q1, which is the second output transistor provided outside of the semiconductor integrated circuit CP3, has positive temperature characteristics, and where the output current Iout that is outputted from the second output transistor Q1 is constant, the current I0 outputted from the first output transistor HV_MP1 has negative temperature characteristics. Furthermore, the current I1 flowing from the drain of the transistor HV_MP2 is a copy of the current I0 outputted from the first output transistor HV_MP1, and thus, the current I1 also has negative temperature characteristics. Furthermore, the current 12 flowing from the drain of the transistor MN2 is generated by copying the current I1, and the current 13 flowing from the drain of the transistor MP2 is generated by copying the current 12, and thus, the currents 12 and 13 have negative temperature characteristics.

The semiconductor device 300 of the present embodiment differs from the semiconductor device 200 of Embodiment 2 in terms of where the resistors are provided, but by adjusting the resistance of the resistors R3 and R4 in a manner similar to the semiconductor device 200 of Embodiment 2, it is possible to adjust the temperature coefficient of the current towards the positive temperature characteristic side. In the semiconductor device 300 of the present embodiment, by increasing the resistance of the resistor R3, it is possible to adjust the temperature coefficient of the current 12 towards the positive temperature characteristic side. Also, by increasing the resistance of the resistor R4, it is possible to adjust the temperature coefficient of the current 13 towards the positive temperature characteristic side. Additionally, by performing two-stage adjustment involving adjustment using the resistor R3 and adjustment using the resistor R4, it is possible to adjust the temperature coefficient of the current 13 flowing in the transistor MP2 towards the positive temperature characteristic side. The positive temperature characteristic side includes not only a case in which the temperature characteristics of the currents 12 and 13 change to positive temperature characteristics, but also the case in which the temperature coefficients of the currents 12 and 13 increase and the temperature characteristics approach positive temperature characteristics.

In the semiconductor device 300 of the present embodiment, the operational amplifier HV_OP1 is constituted of an operational amplifier with a high withstand voltage compatible with the high-power source voltage HV_VDD, and the first output transistor HV_MP1, which is the first output transistor, and the transistor HV_MP2, which is a current transmission transistor that copies the current I0 transmitted from the first output transistor HV_MP1, are constituted of transistors with a high withstand voltage compatible with the high-power source voltage HV_VDD. Meanwhile, the transistors MN1, MN2, MP1, MP2, MN3, and MN4 in the overcurrent protection circuit 32 are constituted of transistors with a low withstand voltage compatible with the low-power source voltage VDD. By changing the resistances of the resistors R3 and R4, it is possible to adjust the temperature characteristics in a manner similar to Embodiment 2. The resistances of the resistors R3 and R4 are adjusted during manufacturing of the semiconductor device 300, for example.

In the present embodiment, a case was described in which the resistors R3 and R4 were provided in the overcurrent protection circuit 32, but the configuration is not limited thereto. For example, a resistor R5 connected between the supply line LB for the ground voltage GND and the source of the transistor MN4 may be additionally provided as a new resistor (not shown), with adjustment of the temperature coefficient of the current flowing through the overcurrent protection circuit being conducted in three stages.

Thus, according to the configuration of the semiconductor device 300 of the present embodiment, if the operational amplifier is operated on the basis of the high-power source voltage HV_VDD, it is possible to form the overcurrent protection circuit of transistors with a low withstand voltage. Therefore, according to the semiconductor device 300 of the present embodiment, it is possible to adjust the threshold current for overcurrent protection using transistors with a low withstand voltage, and thus, it is possible to reduce the chip area compared to a case in which the overcurrent protection circuit is constituted only of transistors with a high withstand voltage. Also, the threshold current for overcurrent protection can be adjusted with greater ease compared to a case in which the overcurrent protection circuit is constituted only of transistors with a high withstand voltage.

The present invention is not limited to the embodiments above. In Embodiments 1 and 2, for example, a case was described in which the size of the transistor, the current of which is copied, and the size of the transistor copying the current are the same (e.g., the first output transistor MP1 being the same size as the transistor MP2). However, the sizes may differ. By changing the ratio of sizes of the transistors, it is possible to adjust the threshold current of the overcurrent protection circuit to a different value.

Also, in Embodiment 1, a case was described in which only the resistor R3 was provided as a resistance unit of the overcurrent protection circuit 12, but the configuration is not limited thereto as long as at least one of the resistor R3, the additional resistor R4 described in Embodiment 2, and the resistor R5 (not shown) is provided.

Also, in Embodiment 2, a case was described in which the resistors R3 and R4 were provided as resistance units of the overcurrent protection circuit 22, but the configuration is not limited thereto as long as at least two of the resistor R3, the resistor R4, and the resistor R5 (not shown) are provided.

Also, in Embodiment 3, a case was described in which the resistors R3 and R4 were provided as resistance units of the overcurrent protection circuit 32, but the configuration is not limited thereto as long as at least one of the resistor R3, the resistor R4, and the resistor R5 (not shown) is provided.

In Embodiment 3, an example was described in which the temperature characteristics are adjusted in two stages: by the resistor R3 connected to the current mirror constituted of the transistors MN1 and MN2, and by the resistor R4 connected to the current minor constituted of the transistors MP1 and MP2. However, by setting current minor pairs having a similar structure in a loopback connection, it is possible to further increase the number of stages at which to adjust the temperature characteristics.

What is claimed is:

1. A semiconductor integrated circuit, comprising:
an operational amplifier that is configured to operate upon receiving supply of a first voltage and output a control voltage on the basis of a reference voltage;
a first output transistor having a first electrode connected to a first voltage line that is a supply line for the first voltage, the first output transistor being configured to transmit a first current on the basis of the control voltage; and
an overcurrent protection circuit that is connected to the operational amplifier, and that includes a resistance unit for adjustment of a temperature coefficient.

2. The semiconductor integrated circuit according to claim 1,
wherein the overcurrent protection circuit includes:
a current transmission transistor that is configured to transmit a second current on the basis of the control voltage;
a first transistor pair that is a transistor pair forming a current minor, that is connected between a second electrode of the current transmission transistor and a second voltage line that is a supply line for a second voltage that differs from the first voltage, the first transistor pair being configured to transmit a third current having a value based on a value of the second current; and
a second transistor pair that is a transistor pair forming a current mirror, that is connected between the first transistor pair and the first voltage line, and that is configured to transmit a fourth current having a value based on a value of the third current.

3. The semiconductor integrated circuit according to claim 2,
wherein a control electrode of the current transmission transistor is connected to a control voltage line to which the control voltage is supplied,
wherein the first transistor pair has a first transistor including a second electrode and a control electrode that are connected to the second electrode of the current transmission transistor and a first electrode that is connected to the second voltage line, and a second transistor including a control electrode that is connected to the control electrode of the first transistor, and
wherein the second transistor pair has a third transistor including a second electrode that is connected to the control voltage line, and a fourth transistor including a second electrode and a control electrode that are connected to a first electrode of the second transistor and a first electrode that is connected to the first voltage line.

4. The semiconductor integrated circuit according to claim 3,
wherein the resistance unit has a first resistor having a first end connected to the first voltage line and a second end connected to a first electrode of the current transmission transistor.

5. The semiconductor integrated circuit according to claim 4,
wherein the first resistor is a resistance element having a negative temperature characteristic and being provided in order to adjust a temperature coefficient of the second current.

6. The semiconductor integrated circuit according to claim 4,
wherein the resistance unit has a second resistor having a first end connected to the second voltage line and a second end connected to a second electrode of the second transistor of the first transistor pair.

7. The semiconductor integrated circuit according to claim 6,
wherein the second resistor is a resistance element having a negative temperature characteristic and being provided in order to adjust a temperature coefficient of the third current.

8. The semiconductor integrated circuit according to claim 6,
wherein the resistance unit has a third resistor having a first end connected to the first voltage line and a second end connected to a first electrode of the third transistor of the second transistor pair.

9. The semiconductor integrated circuit according to claim 8,
wherein the third resistor is a resistance element having a negative temperature characteristic and being provided in order to adjust a temperature coefficient of the fourth current.

10. The semiconductor integrated circuit according to claim 1,
wherein the overcurrent protection circuit includes:
a current transmission transistor having a first electrode connected to the first voltage line, and that is configured to transmit a second current from a second electrode based on the control voltage;
a first transistor pair that is a transistor pair forming a current minor, that is connected between the second electrode of the current transmission transistor and a second voltage line that is a supply line for a second voltage that differs from the first voltage, and that is configured to transmit a third current having a value based on a value of the second current;
a second transistor pair that is a transistor pair forming a current mirror, that is connected between the first transistor pair and a third voltage line that is a supply line for a third voltage, and that is configured to transmit a fourth current having a value based on a value of the third current; and
a third transistor pair that is a transistor pair forming a current minor, that is connected between the second transistor pair and the second voltage line, and that is configured to transmit a fifth current having a value based on a value of the fourth current.

11. The semiconductor integrated circuit according to claim 10,
wherein a control electrode of the current transmission transistor is connected to a control voltage line to which the control voltage is supplied,
wherein the first transistor pair has a first transistor including a second electrode and a control electrode that are connected to the first electrode of the current transmission transistor and a first electrode that is connected to the second voltage line, and a second transistor including a control electrode that is connected to the control electrode of the first transistor,
wherein the second transistor pair has a third transistor including a second electrode and a control electrode that are connected to a second electrode of the second transistor and a first electrode that is connected to the third voltage line, and a fourth transistor including a control electrode that is connected to the control electrode of the third transistor, and
wherein the third transistor pair has a fifth transistor including a second electrode and a control electrode that are connected to a second electrode of the fourth transistor and a first electrode that is connected to the second voltage line, and a sixth transistor including a control electrode that is connected to the control electrode of the fifth transistor and a second electrode that is connected to the operational amplifier.

12. The semiconductor integrated circuit according to claim 11,
wherein the resistance unit has a first resistor having a first end connected to the second voltage line and a second end connected to a first electrode of the second transistor of the first transistor pair.

13. The semiconductor integrated circuit according to claim 12,
wherein the first resistor is a resistance element having a negative temperature characteristic and being provided in order to adjust a temperature coefficient of the third current.

14. The semiconductor integrated circuit according to claim 12,
wherein the resistance unit has a second resistor having a first end connected to the third voltage line and a second end connected to a first electrode of the fourth transistor of the second transistor pair.

15. The semiconductor integrated circuit according to claim 14,
wherein the second resistor is a resistance element having a negative temperature characteristic and being provided in order to adjust a temperature coefficient of the fourth current.

16. The semiconductor integrated circuit according to claim 14,
wherein the resistance unit has a third resistor having a first end connected to the second voltage line and a second end connected to a first electrode of the sixth transistor of the third transistor pair.

17. The semiconductor integrated circuit according to claim 16,
wherein the third resistor is a resistance element having a negative temperature characteristic and being provided in order to adjust a temperature coefficient of the fifth current.

18. The semiconductor integrated circuit according to claim 11,
wherein the first voltage is a high-power source voltage,
wherein the second voltage is a ground voltage,
wherein the third voltage is a low-power source voltage that is lower than the first voltage,
wherein the first output transistor and the current transmission transistor are constituted of MOS transistors with a high withstand voltage compatible with the first voltage, and
wherein the first transistor, the second transistor, the third transistor, the fourth transistor, the fifth transistor, and the sixth transistor are constituted of MOS transistors with a low withstand voltage compatible with the third voltage.

19. The semiconductor integrated circuit according to claim 11,
wherein the sixth transistor of the third transistor pair is connected to an overcurrent protection terminal provided in the operational amplifier.

20. A semiconductor device, comprising:
the semiconductor integrated circuit according to claim 3; and
a second output transistor that is configured to receive the first current and transmit an output current having a value based on a value of the first current.
